(19) United States
(12) Patent Application Publication
(10) Pub. No.: US 2016/0170738 A1
(43) Pub. Date: Jun. 16, 2016

(54) Computer Readable Storage Media and Updating Method Thereof

(71) Applicants: APEX MATERIAL TECHNOLOGY CORP., Keelung City (TW); IMAGINATION BROADWAY LTD., NEW TAIPEI CITY (TW)

(72) Inventors: Shang-Li LEE, KEELUNG (TW); Zong-Bin LIAO, KEELUNG (TW)

(21) Appl. No.: 14/567,135

(22) Filed: Dec. 11, 2014

(51) Int. Cl. G06F 9/445; G06F 13/42

(52) U.S. Cl. CPC G06F 8/665; G06F 13/4221; G06F 13/4282

(57) ABSTRACT

A method, a computing system, and a computer-readable storage medium which stores program instructions and data for execution of a processor are provided. The storage medium divided into a plurality of segments to store program instructions and data for execution of a processor, said computer-readable storage medium comprising: an IVT (interrupt vector table) segment for storing a plurality of interrupt vectors; an ISR (interrupt service routine) segment for storing a plurality of ISRs; an application segment for storing a plurality of application programs of the processor; an update IVT segment for storing a plurality of update interrupt vectors; an update ISR segment for storing a plurality of update ISRs; and an update utility segment for storing a plurality of update programs for updating the IVT segment, the ISR segment and the application segment.

### CROSS-REFERENCE TO RELATED APPLICATIONS

The present application claims the benefit of priority to Taiwan patent application No. 103113662, filed on Apr. 15, 2014, entitled “Computer Readable Storage Media and Updating Method Thereof”, which is hereby incorporated by reference in its entirety.

### FIELD OF THE INVENTION

The present invention relate to an update method for a computer readable storage medium, and more particularly to a method for updating the computer readable storage medium which stores program instructions and data for execution in a computing system.

### BACKGROUND OF THE INVENTION

In computing or information processing system, processors have to rely on storage media to store firmware, embedded within computing or information processing systems, which refers to program instructions for controlling the operation of hardware components associated with the computing or information processing systems. Especially, a consumer electronic product typically has a short development cycle, therefore, it may be necessary to update firmware or data resided in storage media of the consumer electronic product after the products have been sold in the market for correcting problems or improving functionality in the released version. As such. it is a fundamental functionality that users can easily update program instructions and data stored therein storage media in terms of consumer electronic products.

FIG. 1 illustrates a conventional memory storage medium 100 in electronic devices, which is divided into several segments. Referring to FIG. 1, there is shown each segment subject included in the memory storage medium 100. A person of ordinary skill in the art would understand that the memory storage medium 100 may include, but not limited to, a non-volatile-RAM, an EEPROM, or a flash. Generally speaking, interrupts in electronic devices include hardware interrupts and software interrupts, and an interrupt can be carried out by a predetermined interrupt vector. The storage medium 100 such as a memory in electronic devices is connected to a processor (not shown), and it comprises an interrupt vector table (IVT) segment 110, an application segment 120 and an update utility segment 130.

When the electronic device is reset, interrupts are generally disabled during processor initialization. The IVT stored in the memory is initialized before enabling interrupts. The above-mentioned interrupt vector table (IVT) segment 110 stores interrupt vectors that redirect the processor to a right address in the electronic device when an interrupt occurs. Each interrupt vector, or each entry in the IVT 110, generally points to a starting address of a dispatch code, an interrupt service routine (ISR) or a list of ISRs. The base address of the IVT is recorded in the processor. Accordingly, when the processor in the electronic device receives an external or internal interrupt request, it knows which interrupt vector is corresponding to the interrupt based on the interrupt vectors stored in the IVT 110. Typically, the processor suspends the currently executing program, the instruction pointer (IP) is set to the starting address of the dispatch code, and the ISR or the list of ISRs respond to an interrupt when the interrupt occurs. Eventually, the processor returns to where it left off once the ISR has finished.

Referring to FIG. 1, the application segment 120 included in the storage medium 100 generally comprises commonly-used ISRs. The update utility segment 130 included in the storage medium 100 comprises service routines used by the application segment 120 and/or the IVT segment 110. Both the application segment 120 and the update utility segment 130 share the IVT segment 110, so additional program instructions are required to determine which ISR is to be performed either for the application segment 120 or for the update utility segment 130 when the processor receives the interrupt request. However, the aforementioned additional program instructions required to be executed results in an interrupt latency, and consequently deteriorate the system performance.

In summary, there is a need of reducing the interrupt latency when the data content of the storage media in the electronic device is required to be updated.

### SUMMARY OF THE PRESENT INVENTION

In an embodiment of the present invention, there is provided a computer-readable storage medium divided into a plurality of segments to store program instructions and data for execution of a processor, said computer-readable storage medium comprising: an IVT (interrupt vector table) segment for storing a plurality of interrupt vectors; an ISR (interrupt service routine) segment for storing a plurality of ISRs, wherein each of the plurality of interrupt vectors points to one of the plurality of ISRs; an application segment for storing a plurality of application programs of the processor, wherein each of the plurality of ISRs is configured to call a corresponding one of the plurality of application programs; an update IVT segment for storing a plurality of update interrupt vectors; an update ISR segment for storing a plurality of update ISRs, wherein each of the plurality of update interrupt vectors points to one of the plurality of update ISRs; and an update utility segment for storing a plurality of update programs for updating the IVT segment, the ISR segment and the application segment, wherein the plurality of update ISRs are configured to call a corresponding one of the plurality of update programs.

In another embodiment of the present invention, there is provided a update method for a computer-readable storage medium which is divided into a plurality of segments including an IVT (interrupt vector table) segment, an ISR (interrupt service routine) segment, an application segment, an update IVT segment, an update ISR segment, and an update utility segment to store instructions and data for execution of a processor, said update method comprising: performing an ISR in the ISR segment when an interrupt is received to determine whether an update requirement is met; activating a duplicate program in the application segment to reproduce data in the update IVT segment to the IVT segment; resetting the processor after completion of the said reproducing data in the update IVT segment to the IVT segment; performing an update ISR in the update ISR segment according to the IVT segment pointing to the update ISR segment, and thereby activate an update program in the update utility segment; and updating the IVT segment, the ISR segment, and application segment.

In still another embodiment of the present invention, there is provided a computing system, said computing system comprising: a host system, a processor connected to the host system for processing interrupts, a computer-readable storage medium divided into a plurality of segments to store instructions and data for execution of the processor, comprising: an IVT (interrupt vector table) segment for storing a plurality of interrupt vectors; an ISR (interrupt service routine) segment for storing a plurality of ISRs, wherein each of the plurality of interrupt vectors points to one of the plurality of ISRs; an application segment for storing a plurality of application programs, wherein each of the plurality of ISRs is configured to call a corresponding one of the plurality of application programs; an update IVT segment for storing a plurality of update interrupt vectors; an update ISR segment for storing a plurality of ISRs, wherein each of the plurality of interrupt vectors points to one of the plurality of ISRs; and an update utility segment for storing a plurality of update programs, wherein each of the plurality of ISRs is configured to call a corresponding one of the plurality of update programs.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

FIG. 1 illustrates a conventional memory storage medium 100 comprising a plurality of segments.

FIG. 2 illustrates a computer readable storage medium 200 divided into a plurality of segments in accordance with an embodiment of the present invention.

FIG. 3 illustrates a flowchart of an update method for a computer readable storage medium in accordance with an embodiment of the present invention.

FIG. 4 illustrates a block diagram of a computing system 400 suitable for implementing the several embodiments of the present invention.

### DETAILED DESCRIPTION OF THE INVENTION

Reference will now be made in detail to embodiments of the present invention, examples of which are illustrated in the accompanying drawings. While the present invention will be described in conjunction with embodiments, it will be understood that the descriptions are not intended to limit the present invention to these embodiments. On the contrary, the descriptions are intended to cover alternatives, modifications and equivalents, which may be included within the spirit and scope as defined by the appended claims. Furthermore, in the following detailed description, numerous specific details are set forth in order to provide a thorough understanding of embodiments of the present invention. However, one of ordinary skill in the art will understand that embodiments of the present invention may be practiced without these specific details. In other instances, well known methods, procedures, components, and circuits have not been described in detail as not to unnecessarily obscure aspects of the present invention.

Referring to FIG. 2, there is shown a computer readable storage medium 200 which is divided into a plurality of segments in accordance with an embodiment of the present invention. The storage medium 200 is connected to a processor in an electronic device (not shown), and the storage medium 200 comprises an interrupt vector table (IVT) segment 210, an ISR segment 220, an application segment 230, an update IVT segment 240, an update ISR segment 250 and an update utility segment 260.

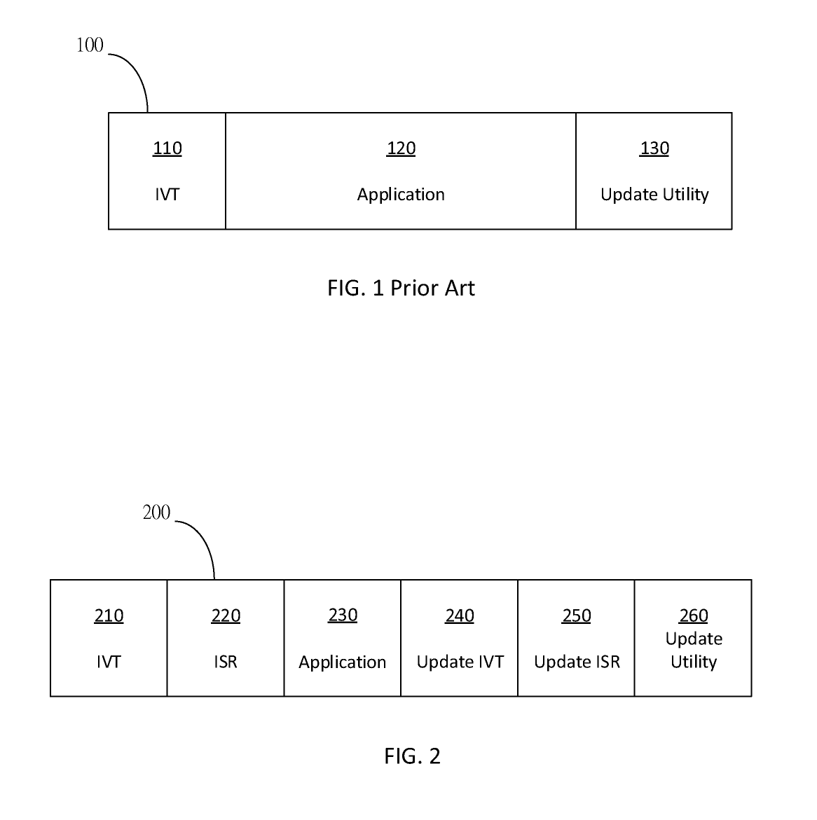

As the embodiment illustrated in FIG. 1, each interrupt vector contained in the IVT segment 210 in FIG. 2 points to a starting address of an ISR resided in the ISR segment 220. All starting addresses of ISRs are stored in the IVT segment 210. The location of ISR program instructions are stored in the ISR segment 220. The program instructions executed by all ISRs in the ISR segment 220 are stored in the application segment 230. Although the ISR segment 220 and the application segment 230 can be separated in accordance with an embodiment of the present invention shown in FIG. 2, the ISR segment 220 and the application segment 230 can be integrated into one segment in accordance with another embodiment of the present invention.

Referring to FIG. 2, each interrupt vector contained in the update IVT segment 240 points to a starting address of an updated ISR resided in the update ISR segment 250. The location of updated ISR code are stored in the update ISR segment 250. The program instructions are stored in the update utility segment 260, and they are executed by all updated ISRs in the update ISR segment 250. Although the update ISR segment 250 and the update utility segment 260 are separated in accordance with an embodiment of the present invention. The update ISR segment 250 and the update utility segment 260 can be integrated into one segment in accordance with another embodiment of the present invention.

In one embodiment, the segments of the storage medium 200 are arranged in a sequential order as shown in FIG. 2. The segments of the storage medium 200 are arranged in a different sequential order according to another embodiment.

In one embodiment, the size of the update IVT segment 240 and the size of the IVT segment 210 are equal. In another embodiment, the size of the update IVT segment 240 is smaller than the size of the IVT segment 210.

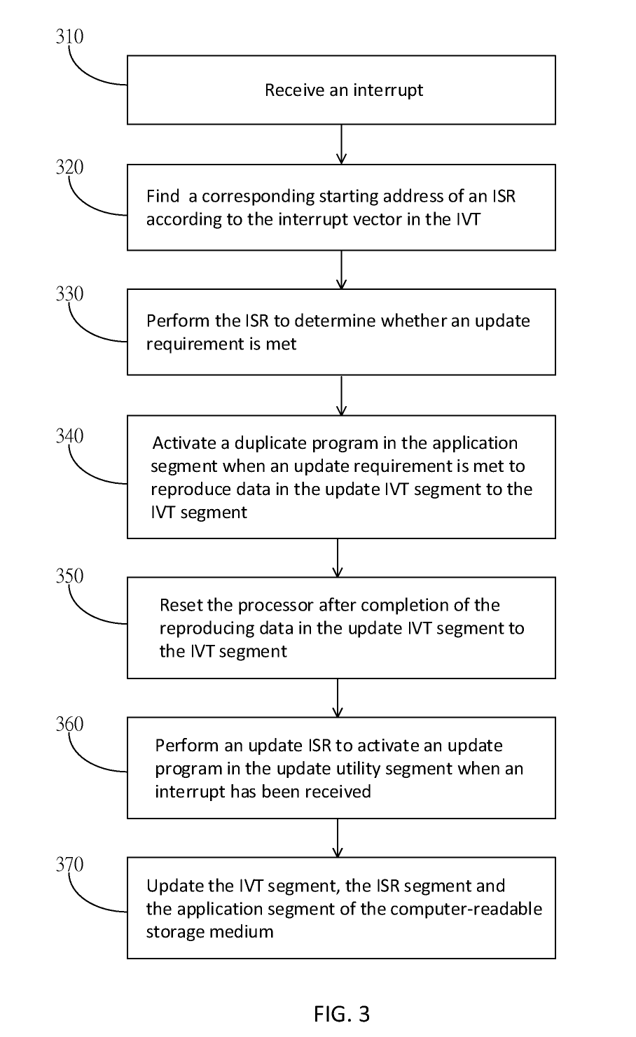

FIG. 3 illustrates a flowchart of an update method for a computer readable storage medium in accordance with an embodiment of the present invention. Correspondingly referring to the storage medium 200 in FIG. 2, the storage medium 200 stores program instructions and data for execution in the computing system having at least one processor. In block 310, an interrupt event is received. The interrupt event pausing the current processor's activity can be an “internal interrupt” or “external interrupt” event.

Next, in block 320, according to the interrupt vector in the IVT segment 210, a corresponding starting address of an ISR resided in the ISR segment 220 is found. In the succeeding block 330, the ISR performs to determine whether a requirement of an updating operation is met. When it is determined that the update requirement is not met, the corresponding application resided in the application segment 230 is called. Consequently, the stored content in the storage medium 200 remains no change because no any update operation is performed, and the method does not proceed to a next step.

When it is determined in that the requirement of the updating operation is met, the method proceeds to block 340. In block 340, a duplicate application resided in the application segment 230 is activated such that the data content in the update IVT segment 240 is reproduced to some entries in the IVT segment 210. In other words, a part of data content in the IVT segment 210 is overwritten by the data content in the update IVT segment 240. Furthermore, the processor is reset after completion of the reproducing data in the update IVT segment to the IVT segment in block 350.

After the processor is reset in block 350, the method proceeds to block 360. In block 360, when a new interrupt occurs, a corresponding starting address of the new ISR is found according to the overwritten part of data content in the IVT segment 210, i.e. the data content from the update IVT segment 240. As mentioned, the update IVT segment 240 points to the update ISR segment 250 so the new ISR in the update ISR segment 250 is performed. Namely, the corresponding update program resided in the update utility segment 260 is called in block 360.

In block 370, some segments such as the IVT 210, the ISR segment 220, and/or the application segment 230 are updated with new data contents after the update program resided in the update utility segment 260 has been executed. If necessary, other segments such as the update IVT segment 240, the update ISR segment 250, and/or the update utility segment 260 are also updated with new data content.

The processor is reset again to its initial state upon completion of all actions in the block 360. When the processor reboots, the updated interrupt services are provided according to the information in the IVT segment 210, the ISR segment 220, and/or the application segment 230.

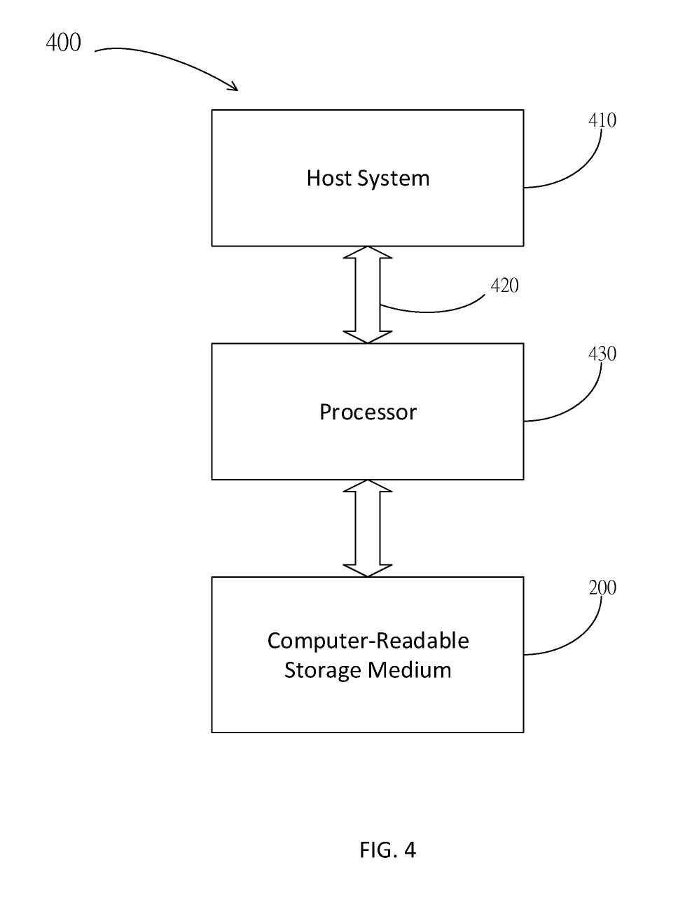

FIG. 4 illustrates a block diagram of a computing system 400 suitable for implementing the several embodiments of the present invention. The computing system 400 comprises a host system 410, a processor 430, and a storage component, e.g. the computer readable storage medium 200. The computing system 400 also comprise an interface 420 adapted to transfer or exchange information between a host system and a processor. The interface 420 may be implemented using at least one bus interface, including but not limited to, such as Universal Serial Bus (USB), Universal Asynchronous Receiver/Transmitter (UART), Inter-Integrated Circuit (I²C,), Serial Peripheral Interface (SPI), Personal Computer Interface(PCI), Personal Computer Interface-express (PCI-e).

Although the computing system 400 includes only one processor 430 shown in FIG. 4. In another embodiment, the computing system 400 may include multiple processors 430. On the other hand, the processor 430 and the computer readable storage medium 200 are resided in separate chips or an identical chip. One of ordinary skill in the art will understand that embodiments of the present invention may be practiced in either way.

It will further be appreciated by those skilled in the art that the processor 430 is used to perform an update task for the computer readable storage medium with the control flow as shown in FIG. 3. While the block 360 is performing, the processor 430 sends a request for data content to the host system 410 via the interface 420. Accordingly, all data contents for updating the IVT segment, the ISR segment and the application segment are acquired from the host system 410 via the interface 420. In some embodiments, all data content are acquired from other components via the interface 420, for example, the other components is a memory or a storage device resided in the computing system 400.

In summary, the characteristics of the invention provides as indicated in the description and the drawings are to provide two set of IVTs and its associated ISRs and program instructions in the computer readable storage medium. In this manner, the system can make the updating task for the data content of the computer readable storage medium go more smoothly and less interrupt latency.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A computer-readable storage medium divided into a plurality of segments to store program instructions and data for execution of a processor, comprising:
an IVT (interrupt vector table) segment for storing a plurality of interrupt vectors;
an ISR (interrupt service routine) segment for storing a plurality of ISRs, wherein each of the plurality of interrupt vectors points to one of the plurality of ISRs;
an application segment for storing a plurality of application programs of the processor, wherein each of the plurality of ISRs is configured to call a corresponding one of the plurality of application programs;
an update IVT segment for storing a plurality of update interrupt vectors;
an update ISR segment for storing a plurality of update ISRs, wherein each of the plurality of update interrupt vectors points to one of the plurality of update ISRs; and
an update utility segment for storing a plurality of update programs for updating the IVT segment, the ISR segment and the application segment, wherein the plurality of update ISRs are configured to call a corresponding one of the plurality of update programs.

2. The computer-readable storage medium of claim 1, wherein a base address of the IVT is recorded in the processor.

3. The computer-readable storage medium of claim 1, wherein data for updating the IVT segment, the ISR segment and the application segment is acquired from a host system.

4. The computer-readable storage medium of claim 1, wherein a duplicate program is stored in the application segment for reproducing data in the update IVT segment to the IVT segment.

5. The computer-readable storage medium of claim 4, wherein when one of the plurality of ISRs is performed, the one of the plurality of ISRs determines whether an update requirement is met, and the duplicate program is activated when the update requirement is met.

6. The computer-readable storage medium of claim 4, wherein the processor is reset after completion of the said reproducing of data in the update IVT segment to the IVT segment.

7. A update method for a computer-readable storage medium which is divided into a plurality of segments including an IVT (interrupt vector table) segment, an ISR (interrupt service routine) segment, an application segment, an update IVT segment, an update ISR segment, and an update utility segment to store instructions and data for execution of a processor, comprising:
performing an ISR to determine whether an update requirement is met, wherein a corresponding starting address of the ISR found in the IVT points to the ISR segment when an interrupt has been received;
activating a duplicate program in the application segment when an update requirement is met to reproduce data in the update IVT segment to the IVT segment;
resetting the processor after completion of the reproducing data in the update IVT segment to the IVT segment;
performing an update ISR to activate an update program when an interrupt has been received, wherein a corresponding starting address of the update ISR found in the IVT points to an identical location as that in the update ISR segment and thereby activate the update program in the update utility segment; and
updating the IVT segment, the ISR segment and the application segment.

8. The update method of claim 7, wherein a base address of the IVT is recorded in the processor.

9. The update method of claim 7, wherein data for updating the IVT segment, the ISR segment and the application segment are acquired from a host system.

10. A computing system, comprising:
a host system;
a processor connected to the host system for processing interrupts; and
a computer-readable storage medium divided into a plurality of segments to store instructions and data for execution of the processor, comprising:
an IVT (interrupt vector table) segment for storing a plurality of interrupt vectors;
an ISR (interrupt service routine) segment for storing a plurality of ISRs, wherein each of the plurality of interrupt vectors points to one of the plurality of ISRs;
an application segment for storing a plurality of application programs, wherein each of the plurality of ISRs is configured to call a corresponding one of the plurality of application programs;
an update IVT segment for storing a plurality of update interrupt vectors;
an update ISR segment for storing a plurality of ISRs, wherein each of the plurality of interrupt vectors points to one of the plurality of ISRs; and
an update utility segment for storing a plurality of update programs, wherein each of the plurality of ISRs is configured to call a corresponding one of the plurality of update programs.

11. The computing system of claim 10, wherein a base address of the IVT is recorded in the processor.

12. The computing system of claim 10, wherein the host system and the processor transfer data via one of the following interfaces: Universal Serial Bus (USB), Universal Asynchronous Receiver/Transmitter (UART), Inter-Integrated Circuit (I²C,), Serial Peripheral Interface (SPI), Personal Computer Interface(PCI), or Personal Computer Interface-express (PCI-e).

13. The computing system of claim 10, wherein data for updating the IVT segment, the ISR segment and the application segment is acquired from the host system.

14. The computing system of claim 10, wherein a duplicate program is stored in the application segment for reproducing data in the update IVT segment to the IVT segment.

15. The computing system of claim 14, wherein when one of the plurality of ISRs is performed, the one of the plurality of ISRs determines whether a update requirement is met, and the duplicate program is activated when the update requirement is met.

16. The computing system of claim 14, wherein the processor is reset after completion of the said reproducing of data in the update IVT segment to the IVT segment.
